(19) United States
(12) Patent Application Publication
(10) Pub. No.: US 2011/0080257 A1
(43) Pub. Date: Apr. 7, 2011

(54) CONFIGURABLE DISPLAY FOR SIGNAL ACTIVATED DEVICE

(75) Inventor: MARK A. BUCKNER, OAK RIDGE, TN (US)

(73) Assignee: UT BATTELLE LLC, OAK RIDGE, TN (US)

(21) Appl. No.: 12/573,445

(22) Filed: Oct. 5, 2009

(51) Int. Cl. G05B 19/00; G09G 5/00

(52) U.S. Cl. 340/5.8; 340/5.1; 345/156

(57) ABSTRACT

A system for providing a configurable display for a signal activated device may include a receiver, a memory, a processor, and a display. The receiver may be operative to receive a radio frequency signal. The memory may be coupled with the receiver, and may be operative to store an item. The processor may be coupled with the memory and may be operative to retrieve the item stored in the memory, in response to the activation signal received by the receiver. The processor may use a current induced in the receiver by the radio frequency signal to retrieve the item. The display may be coupled with the processor and may be operative to display the item retrieved from memory using the current induced in the receiver.

### STATEMENT REGARDING FEDERALLY SPONSORED RESEARCH

This invention was made with government support under Contract No. DE-AC05-00OR22725 awarded by the U.S. Department of Energy. The government has certain rights in the invention.

### TECHNICAL FIELD

The present description relates generally to a system and method, generally referred to as a system, for providing a configurable display for a signal activated device, and more particularly, but not exclusively, to providing a configurable display for a radio frequency identification device, which is also may be referred to as a “smart label.”

### BACKGROUND

Radio frequency identification (“RFID”) devices store data, such as an identifier, in a memory, and transmit the data when activated by an external source, such as an RFID antenna. RFID devices may be attached to objects, such as shipping crates, and may be used to track the location of the object as it progresses to its destination. RFID antennas positioned in warehouses, and/or on shipping vehicles, may send radio frequency signals to activate the RFID devices when the RFID devices pass by, proximate to or within the vicinity of, the RFID antennas. The activated RFID devices may respond to the signals by sending the data stored in the memory of the devices to the RFID antennas.

An RFID device may have a machine and/or human readable label attached; alternatively, an RFID device may be embedded in a machine and/or human readable label. The label may display information describing the data stored in the memory of the device, thereby allowing for humans and/or machines to identify the RFID device or asset without having to activate the device. Unfortunately the information displayable by the labels is fixed, which may not be desirable in every implementation. For example, if an object with an RFID device attached is travelling through intermediaries as it progresses to its destination, it may be undesirable to display the information while the object is travelling through the intermediaries, while it may be desirable to display the information when the object reaches its destination.

The memory of the RFID devices may be rewritable, allowing for the devices to be re-used and/or re-purposed; however, the labels attached to the devices may not be rewritable. Thus, each time the memory of a device is re-written, a new label must be printed to ensure the information displayed on the label accurately describes the data stored in the memory. Unfortunately, end users of RFID devices generally lack the resources, e.g. equipment, time, personnel, necessary for re-printing labels each time the memory is rewritten. Furthermore, labels with an embedded RFID device may not be re-printable, thus negating the reusability of the RFID device altogether.

### SUMMARY

A system for providing a configurable display for a signal activated device may include a receiver, a memory, a processor, and a display. The receiver may be operative to receive a signal, such as a radio frequency signal, an optical signal, or generally any transmittable signal. The memory may be coupled with the receiver, and may be operative to store an item. The processor may be coupled with the memory and/or the receiver, and may be operative to retrieve the item stored in the memory, in response to the activation signal received by the receiver. The processor may use a current induced in the receiver by the radio frequency signal to retrieve the item. The current may also be used to store a charge, such as in a rechargeable battery, a capacitor, or a printable charge storage. The display may be coupled with the processor and may be operative to display the item retrieved from memory using the current induced in the receiver. The receiver may also include a photovoltaic device to convert light, such as from the environment or from a bar code or scanner, to power the system or store a charge.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for providing a configurable display for a signal activated device.

FIG. 2 is a block diagram illustrating the components of an exemplary passive signal activated device in the system of FIG. 1 or other systems for providing a configurable display for a signal activated device.

FIG. 3 is a block diagram illustrating the components of an exemplary active signal activated device in the system of FIG. 1 or other systems for providing a configurable display for a signal activated device.

FIG. 4 is a flowchart illustrating the operations of displaying an item stored in memory in the systems of FIG. 1, FIG. 2, and FIG. 3, or other systems for providing a configurable display for a signal activated device.

FIG. 5 is a flowchart illustrating the operations of displaying an item stored in secure memory in the systems of FIG. 1, FIG. 2, and FIG. 3, or other systems for providing a configurable display for a signal activated device.

FIG. 6 is a flowchart illustrating the operations of rewriting the memory of a signal activated device in the systems of FIG. 1, FIG. 2, and FIG. 3, or other systems for providing a configurable display for a signal activated device.

FIG. 7 is a block diagram of an inactivated exemplary signal activated device in the systems of FIG. 1, FIG. 2, and FIG. 3, or other systems for providing a configurable display for a signal activated device.

FIG. 8 is a block diagram of an activated exemplary signal activated device in the systems of FIG. 1, FIG. 2, and FIG. 3, or other systems for providing a configurable display for a signal activated device.

### DETAILED DESCRIPTION

A system and method, generally referred to as a system, may relate to providing a configurable display for a signal activated device, and more particularly, but not exclusively, to providing a configurable display for a radio frequency identification device. The principles described herein may be embodied in many different forms.

The system provides a configurable display for displaying data stored in the memory of a signal activated device, such as a radio frequency identification (RFID) device or a contact memory button, in addition or in lieu of transmitting the stored data via an RF signal. The data may be displayed in a human and/or machine readable form, such as textual characters or bar codes. The data may be displayed in different languages, such as depending on the location of a user and/or the device. The data may be displayed on the display when the signal activated device receives an activation signal. The activation signal may be a radio frequency signal, an optical signal, a magnetic signal, an infra-red signal, a touch signal, or generally any signal capable of being received by the signal activated device. The system may allow the memory in the signal activated device to be rewritten. Each time the memory is rewritten the display may be configured to display the new data written to the memory, thereby providing verification that the memory was successfully rewritten. Thus, providing a configurable display allows a signal activated device, such as an RFID device, to be reused and/or repurposed while ensuring the information displayed on the device accurately reflects the data stored in the memory.

The system may secure the data stored in the signal activated device by requiring that a security criterion is satisfied before displaying the data on the display. For example, the security criterion may require a human or machine user to input a password or provide a fingerprint scan, such as for authentication. The security criterion may be implemented by one or more security mechanisms, such as a password mechanism, a fingerprint mechanism, a location detection mechanism, or generally any security mechanism. In one instance the display of the RFID device may be touch sensitive and may be capable of receiving a fingerprint scan or a password provided by a user. Alternatively or in addition a location detection mechanism, such as a positioning system, may be embedded in the RFID device. In this case the security criterion may be satisfied when the device is located within a determined geographic area, such as within a warehouse.

The configurable display may provide a secondary verification method for handheld readers to ensure the validity of a signal activated device and/or any items associated with the signal activated device. For example, the configurable display of a signal activated device may display a linear or two-dimensional bar code, or other symbology, representing the data stored in the memory of the signal activated device. A bar code reader may be capable of reading the bar code and receiving a radio frequency signal from the signal activated device. The bar code reader may verify that the data provided by the bar code matches the data received from the signal activated device. A conflict between the data read on the bar code and the data received from the signal activated device may indicate a security breach, a device malfunction, or generally may identify a problem with the signal activated device. The device may also incorporate piezo acoustic/audible and/or vibration sensors into the secondary verification method.

The system may allow a device to display human or machine readable data on demand which is consistent with data stored in the memory of the device, such as a smart tag or a contact memory button. The data stored in the memory of the device may be modified electronically. The display prevents labeling data from being inconsistent when data stored in the memory of the device is modified. The data displayed may change based on the context, security, location, authentication, such as authorization, when the data is read from the device. The system may display multi-type or multi-level data, multi-language data, price updates, destination information, or generally any data of interest relating to the device. The system may also display the status or health of an asset which the device is attached to, or sensor/data readings generated by the device.

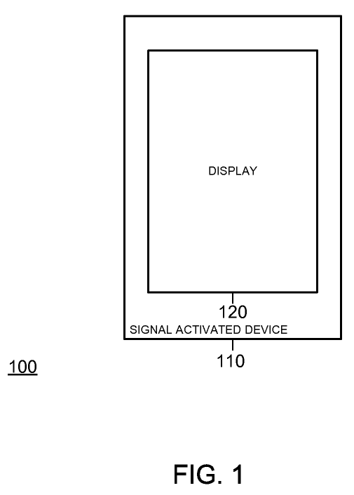

FIG. 1 provides a general overview of a system 100 for providing a configurable display for a signal activated device. Not all of the depicted components may be required, however, and some implementations may include additional components. Variations in the arrangement and type of the components may be made without departing from the spirit or scope of the claims as set forth herein. Additional, different or fewer components may be provided.

The system 100 may include a signal activated device 110, such as an RFID device, and a display 120, such as a configurable display. The signal activated device 110 may be an RFID tag, such as a smart label or a smart active label, or generally any device capable of being activated by a signal. The display 120 may be a low power dynamically configurable/controllable display, such as an organic light-emitting diodes (OLED) display, an organic thin-film transistors (OTFT) display, functional nanomaterials, or any device capable of displaying human and/or machine readable information. The display may be integrated into, or be an integral part of the signal activated device 110. The signal activated device 110 and the display 120 may be integrated or otherwise operatively attached, and may be in communication with one another. The display 120 may cover the entire surface of the signal activated device 110.

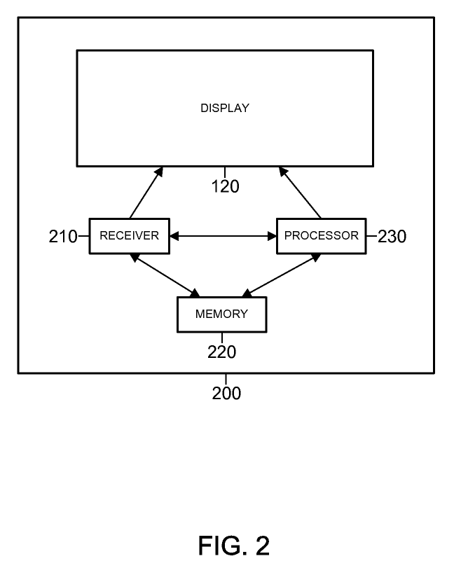

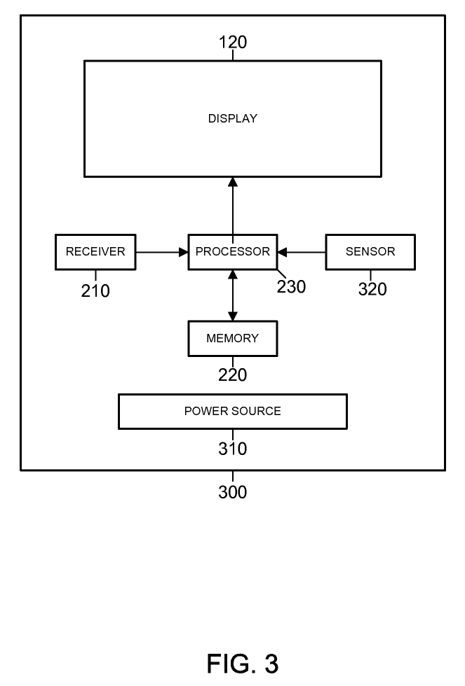

The signal activated device 110 may include a memory for storing data, a receiver for sending and receiving data, such as an antenna, and a processor. The signal activated device 110 may also include a power source, such as a battery, a capacitor, functional nanomaterials, or photovoltaic cells, a positioning device, such as a global positioning device (GPS), and a sensor, such as a touch sensor, humidity sensor, motion sensor, light sensor, fingerprint reader, or generally any sensor capable of receiving input. The components of exemplary signal activated devices 110 may be discussed in more detail in FIGS. 2 and 3 below.

In operation, the system 100 may be attached, implanted, or inserted to an object, such as a product, for the purpose of identifying the object using radio frequency signals. In one example the system 100 may be attached to the side of a shipping crate, box or container. The display 120 of the system 100 may display information describing the contents of the shipping crate when the system 100 receives an activation signal. For example, an antenna of the signal activated device 110 may receive an activation signal in the form of a radio frequency signal. The radio frequency signals may be generated by an antenna positioned external to the signal activated device 110, such as in a warehouse and/or on a shipping vehicle. Alternatively or in addition the system 100 may receive an activation signal in other forms, such as a low frequency radio wave signal, an optical signal, such as through a bar code reader or other symbol reader, a magnetic signal, a signal received from a touch sensor, or generally any signal capable of activating the system 100. In some instances the system 100 may include additional sensors to implement the activation functionality, such as a touch sensor, a light sensor, a magnetic sensor or generally any sensor capable of receiving an external stimulus. The system 100 may also receive an internal activation signal, such as a signal generated by an internal timer.

The display 120 may display information in a human or machine readable format. Information displayed in a human readable format may be displayed in the language used in the geographic region where the system 100 is currently located. The system 100 may determine the geographic region based on a positioning device included in the system 100. Alternatively or in addition the activation signal sent to the system 100, such as a radio frequency signal, may include data identifying the language the information should be displayed in. Information displayed in a machine readable format may be displayed in a bar code, or generally in any format capable of being read by a machine.

Alternatively or in addition, the display 120 may provide a three-dimensional visualization, such as a three-dimensional display demonstrating the location of the contents of a shipping crate. The three-dimensional display may be true 3D or holographic visualization. Alternatively or in addition, the display 120 may display a two-dimensional visualization, such as a map displaying the route the crate has travelled. In this instance the system 100 may store geographic data, such as coordinates, in the memory of the signal activated device 110 each time the system 100 is activated by an activation signal. The geographic data may be received from the activation source, such as an external RFID antenna, or from an internal positioning device.

The system 100 may implement one or more security criterions to secure the data stored in the memory of the signal activated device 110. The security criterion may include a password protection mechanism, a fingerprint verification mechanism, a secure location detection mechanism, an encryption mechanism, or generally any security mechanism capable of securing the data stored in the memory of the signal activated device 110. The system 100 may include additional components to implement the security criterion, such as a password input device, a fingerprint reader, or a positioning system. In one instance the display 120 may be touch sensitive and may be capable of receiving an inputted password or a scan of a fingerprint. Alternatively or in addition the data stored in the memory may be encrypted. In this case, an encryption key may be provided by the activating signal in order to decrypt and view the data stored in the memory.

FIG. 2 provides a view of the components of an exemplary passive signal activated device 200 in the system of FIG. 1, or other systems for providing a configurable display for a signal activated device. Not all of the depicted components may be required, however, and some implementations may include additional components. Variations in the arrangement and type of the components may be made without departing from the spirit or scope of the claims as set forth herein. Additional, different or fewer components may be provided.

The passive signal activated device 200 may include a display 120, a receiver 210, a memory 220, and a processor 230. The passive signal activated device 200 may be a signal activated device 110 without an internal power source. The passive signal activated device 200 may be a passive RFID device, such as a smart label. The display 120, receiver 210, memory 220, and processor 230 may be operatively connected in the passive signal activated device 200.

The receiver 210 may be any device capable of receiving an activation signal, such as an antenna capable of receiving radio frequency signals, such as low frequency radio signals, high frequency radio signals, ultra-high frequency radio signals, ultra-wideband (UWB) signals, or optical signals, such as laser signals, infra-red signals, ultraviolet signals. In the case of infrared and/or photovoltaic signals, the layers for receiving the signals may be transparent and may or may not be part of the passive signal activated device 200. The receiver 210 may also be capable of transmitting radio frequency signals. The receiver 210 may be an integrated part of the display 120. The receiver 210 may be capable of receiving induced current generated by activation signals. For example, in the case of an antenna, incoming radio frequency signals may induce current in the antenna. The current induced in the antenna may be used to power the passive signal activated device 200. The memory may be any device capable of storing data, such as an electrically erasable programmable read-only memory (EEPROM), such as memory including electro or chemical luminescent cells, infra-red cells, or ultra-violet cells. The display 120 may be any lower power dynamically configurable/controllable display, such as an OLED display or an OTFT display.

In operation, the passive signal activated device 200 may be attached to an object, such as a shipping crate, and the memory 220 may be programmed with information describing the contents of the shipping crate. When the shipping crate travels within range of an external antenna, the receiver 210 of the passive signal activated device 200 may receive an activation signal generated by the external antenna, such as a radio frequency signal. Alternatively the passive signal activated device 200 may receive an activation signal from a built-in, embedded or integral antenna. The activation signal may induce a current in the receiver 210, which may be used to power the passive signal activated device 200. The processor 230 may verify that any security criterion are satisfied and then may retrieve the data stored in the memory 220. The processor 230 may process the data, such as format the data into a machine-readable and/or human-readable form, and may display the data on the display 120. Alternatively, the processor 230 may provide an audio indication, such as a beep, a chirp, or any other audio indication, to confirm the data was processed or to assist the user with locating the passive signal activated device 200. The data may be displayed for a period of time, until passive signal activated device 200 travels out of range of the signal, or until a response is received from a machine or human, such a human touching the display 120 or a machine scanning the display 120 with a bar code reader. In one example, the data displayed on the device 200 may be real-time pricing on retail/wholesale shelves in a store.

When the shipping crate reaches its destination, the crate may no longer require the passive signal activated device 200. In this instance the passive signal activated device 200 may be attached to a second object and the memory 220 may be re-programmed with data describing the second object. Alternatively the passive signal activated device 200 may be deactivated or destroyed. Each time the memory 220 is re-written with new data, the processor 230 may configure the display 120 to display the new data. Displaying the new data on the display 120 allows a user to verify that the memory 220 was successfully rewritten with the new data.

FIG. 3 provides a view of the components of an exemplary active signal activated device 300 in the system of FIG. 1, or other systems for providing a configurable display for a signal activated device. Not all of the depicted components may be required, however, and some implementations may include additional components. Variations in the arrangement and type of the components may be made without departing from the spirit or scope of the claims as set forth herein. Additional, different or fewer components may be provided.

The active signal activated device 300 may include a display 120, a receiver 210, a memory 220, a processor 230, a sensor 320, and a power source 310. The active signal activated device 300 may be a signal activated device 110 with an internal power source 310. The active signal activated device 300 may be an active RFID device, such as a smart active label. The display 120, receiver 210, memory 220, processor 230, sensor 320 and power source 310 may be operatively connected in the active signal activated device 300.

The receiver 210 may be any device capable of receiving an activation signal, such as an antenna capable of receiving radio frequency signals. The antenna may also be capable of sending and receiving low frequency signals, high frequency signals, ultra-wide band signals, and/or ultra-high frequency signals. Alternatively or in addition, the receiver 210 may be capable of receiving current induced by activation signals. For example, in the case of an antenna, incoming radio frequency signals may induce current in the antenna, or in a nano-wire structure. The current induced in the antenna may be used to provide additional power to the active signal activated device 300. The memory 220 may be any device capable of storing data, such as an EEPROM. The display 120 may be any low power dynamically configurable/controllable display, such as an OLED display or an OTFT display. The power source 310 may be any device capable of providing power to the components of the active signal activated device 300, such as a lithium-ion battery, a nickel-cadmium battery, or a hydrogen fuel cell.

The sensor 320 may be any sensor capable of receiving input external to the active signal activated device 300, such as a temperature sensor, a touch sensor, a fingerprint reader, a humidity sensor, a vibration sensor, a tamper sensor, a light sensor, a positioning sensor, such as a positioning system, or a nuclear radiation sensor. The sensor 320 may be used to implement a security criterion in the active signal activated device 300. For example, in the case of a sensor 320 as a touchpad, the active signal activated device 300 may require a password be entered via the sensor 320 before displaying the data stored in the memory 220 on the display 120. In the case of a tamper sensor, the sensor 320 may be used in as part of a tamper-indication device or an anti-tamper device. The processor 230 may verify that the inputted password matches a password stored in the memory 220 or a password stored in a memory external to the active signal activated device 300. Alternatively or in addition, if the sensor 320 includes a fingerprint reader, the active signal activated device 300 may require a fingerprint be provided before displaying the data stored in the memory 220 on the display 120. The processor 230 may verify that the fingerprint matches a fingerprint profile stored in the memory 220 or a fingerprint profile stored in a memory external to the active signal activated device 300.

In operation, the active signal activated device 300 may be attached to an object, such as a shipping crate, and the memory 220 may be programmed with information describing the contents of the shipping crate. When the shipping crate travels within the range of an external antenna, the receiver 210 of the active signal activated device 300 may receive an activation signal generated by the external antenna, such as a radio frequency signal. The activation signal may include authorization information. The activation signal may induce a current in the receiver 210, which may be used to provide additional power to the active activated device 300. The processor 230 may determine whether any security criterion have been set for the active signal activated device 300. For example, a security criterion may require a secondary input be provided via the sensor 320. If a security criterion has been set for the active signal activated device 300, the processor 230 may determine whether the security criterion has been satisfied. If the processor 230 determines that the security criterion has not been satisfied, the processor 230 may display an error message on the display 120.

Once the processor 230 verifies that any existing security criterion is satisfied, the processor 230 retrieves the data stored in the memory 220. The processor 230 may process the data, such as format the data into a machine-readable and/or human-readable form, and may display the data on the display 120. The data may be displayed for a period of time, until the active signal activated device 300 travels out of range of the signal, or until a response is received from a machine or human, such a human touching the display 120 or a machine scanning the display 120 with a bar code reader. The memory 220 may store a record or log of unauthorized or failed attempts to read/query the active signal activated device 300. The record or log may include geolocation data, such as from a positioning system, which describes the location of the active signal activated device 300 when the unauthorized attempts occurred, as well as the readings on any sensors when the unauthorized attempts occurred.

When the shipping crate reaches its destination, the crate may no longer require the active signal activated device 300. In this case, the memory 220 of the active signal activated device 300 may be attached to a second object and the memory 220 may be re-programmed with data describing the second object. Each time the memory 220 is re-written with new data, the processor 230 may configure the display 120 to display the new data. Displaying the new data on the display 120 allows a user to verify that the memory 220 was successfully rewritten with the new data.

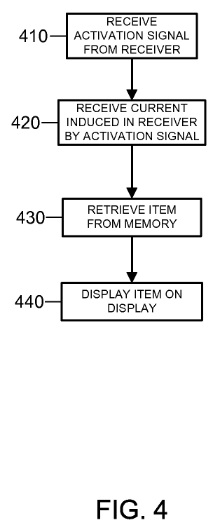

FIG. 4 is a flowchart illustrating the operations of displaying an item stored in memory in the systems of FIG. 1, FIG. 2, and FIG. 3, or other systems for providing a configurable display for a signal activated device. At step 410, the system 100 receives an activation signal via the receiver 210. For example, in the case of an RFID device, the receiver 210 may be an antenna, and may receive a radio frequency signal. The radio frequency signal may be generated by an antenna external to the system 100, such as an antenna positioned in a warehouse.

Alternatively or in addition, if the system 100 implements a power source 310, the system 100 may receive an internal activation signal. For example, the processor 230 may be programmed to send an activation signal after a period of time has elapsed. Alternatively or in addition, if the system 100 implements a sensor 320, the activation signal may be received via the sensor 320. For example, an optical sensor 320 may receive an optical activation signal, such as a laser generated by a bar code reader, a magnetic sensor 320 may receive a magnetic activation signal, such as a magnetic device passing in close proximity of the magnetic sensor 320, or an infra-red sensor 320 may receive an infra-red activation signal. Alternatively or in addition, the sensor 320 may be a touch-sensitive sensor. In this case, the activation signal may be generated when an operator touches the sensor 320.

At step 420, the system 100 may receive current induced in the receiver 210 by the activation signal. The current may be used to power the system 100. In the case of an RFID device, a current may be induced in the antenna and used to power the RFID device. Alternatively or in addition, if the system 100 may be powered by an internal power source 310. At step 430, the processor 230 retrieves the item stored in memory, such as information describing the contents of a shipping crate the signal activated device 100 is attached to, the destination of the shipping crate, any sensor readings, such as the temperature, and/or any chain of custody information. At step 440 the processor 230 may configure the display 440 to display the item stored in memory. OLED or OTFT displays may be configured by communicating the new data to the display 120. The item may be displayed on the display 120 for a period of time, until the receiver 210 is out of range of the activation signal, or until the system 100 receives input from an operator and/or machine.

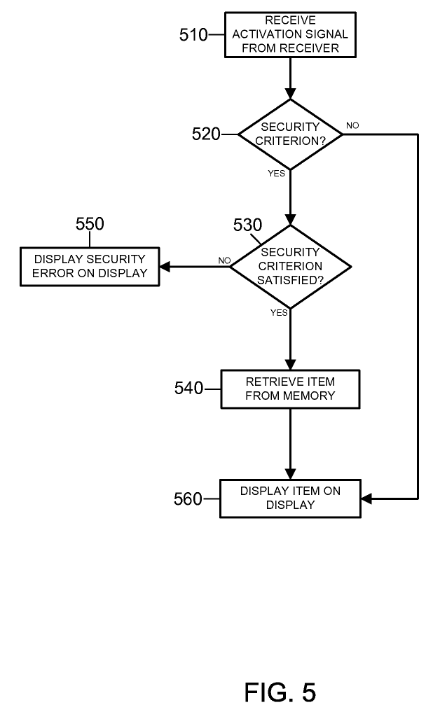

FIG. 5 is a flowchart illustrating the operations of displaying an item stored in secure memory in the systems of FIG. 1, FIG. 2, and FIG. 3, or other systems for providing a configurable display for a signal activated device. At step 510, the system 100 receives an activation signal via the receiver 210. For example, in the case of an RFID device, the receiver 210 may be an antenna and may receive a radio frequency signal. The radio frequency signal may be generated by an antenna external to the system 100, such as an antenna positioned in a warehouse, or a handheld device.

Alternatively or in addition, if the system 100 implements a power source 310, the system 100 may receive an internal activation signal. For example, the processor 230 may be programmed to send an activation signal after a period of time has elapsed. Alternatively or in addition, if the system 100 implements a sensor 320, the activation signal may be received via the sensor 320. For example, an optical sensor 320 may receive an optical activation signal, such as a laser generated by a bar code reader, a magnetic sensor 320 may receive a magnetic activation signal, such as a magnetic device passing in close proximity of the magnetic sensor 320, or an infra-red sensor 320 may receive an infra-red activation signal.

At step 520, the system 100 may determine whether the memory 220 has been secured with a security criterion. The security criterion may require a secondary verification, such as receiving a password or fingerprint provided by a user, identifying the positional coordinates describing the current location of the system 100, receiving an encryption key, or generally any security mechanism capable of preventing unauthorized access to the memory 220.

If, at step 520, the system 100 determines that the memory 220 has been secured with a security criterion, the system 100 moves to step 530. At step 530, the system 100 determines whether the security criterion has been satisfied. In the case of a password protection mechanism, the system 100 may require a user to enter a password via a touch sensor 320, or a display 120 which is touch-sensitive. The processor 230 may verify that the password inputted by the operator matches a password stored in the memory 220, or a password in a memory of an external device, such as a remote server.

If, at step 530, the system 100 determines that the security criterion has not been satisfied, the system 100 moves to step 550. At step 550, the system 100 configures the display 120 to display a security error message. The security error message may indicate that the security criterion was not satisfied. If, at step 530, the system 100 determines that the security criterion has been satisfied, the system 100 moves to step 540. At step 540, the processor 230 may retrieve the item stored in the memory 220. The item retrieved from the memory may differ depending on the authorization level of the current user/device if the system 100 utilizes role-based or content based multi-level authentication system.

If, at step 520, the system 100 determines that the memory 220 is not secured with a security criterion, the system 100 moves to step 560. At step 560 the system 100 displays the item stored in the memory 220 on the display 120 in human and/or machine readable form. The item may be displayed in human readable form using text or graphics, such as text describing the contents of the object the system 100 is attached to. The item may be displayed in machine readable form using a bar code or other machine readable indicia. The bar code may be associated with the object the system 100 is attached to. The item may be displayed on the display 120 for a determined period of time, until the receiver 210 is out of range of the activation signal, or until the system 100 receives input from an operator and/or machine.

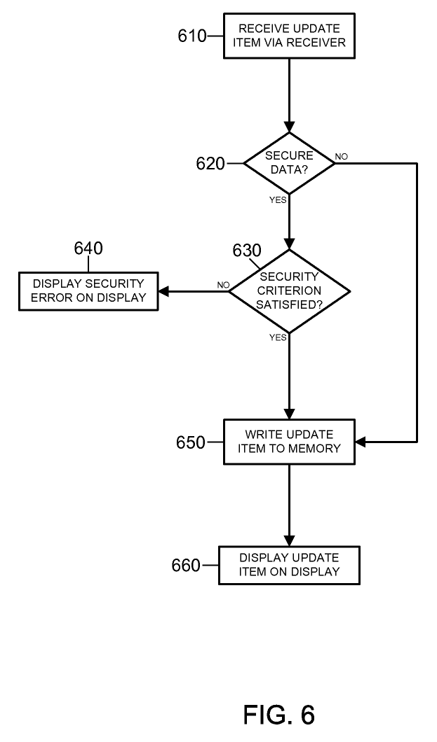

FIG. 6 is a flowchart illustrating the operations rewriting the memory of a signal activated device of the systems of FIG. 1, FIG. 2, and FIG. 3, or other systems for providing a configurable display for a signal activated device. At step 610, the system 100 receives an update item via the receiver 210. For example, in the case of an RFID device, the receiver 210 may be an antenna and the receiver 210 may receive a radio frequency signal including the update item. The radio frequency signal may be generated by an antenna external to the system 100, such as an antenna positioned in a warehouse.

At step 620, the system 100 determines whether a security criterion has been implemented for controlling write access to the memory 220. The system 100 may implement a security criterion for controlling write access to the memory 220 in order to prevent unauthorized memory rewrites. If, at step 620, the system 100 determines a security criterion has been implemented for controlling write access to the memory 220, the system 100 moves to step 630. At step 630, the system 100 determines whether the security criterion has been satisfied. Satisfying the security criterion may require additional input from a human or machine user, such as inputting a password, providing a fingerprint, or generally any input which may be used to implement a security mechanism.

If, at step 630, the system 100 determines that the security criterion was not satisfied, or if, at step 620, the system 100 determines no security criterion was implemented, the system 100 moves to step 640. At step 640, the system 100 displays a security error message on the display 120. The security error message may indicate that the memory was not written because the security criterion was not satisfied. Alternatively, an unauthorized attempt may display nothing. If, at step 630, the system 100 determines that the security criterion was satisfied, the system 100 moves to step 650. At step 650, the system 100 rewrites the memory 220 with the update item. Alternatively or in addition, the system 100 may append the update item to the memory 220.

At step 660, the system 100 displays the update item on the display 120 in human and/or machine readable form. Displaying the update item on the display may provide verification to the human and/or machine operator that the update item was successfully written to the memory. The update item may be displayed for a period of time, until the receiver 210 is out of range of the activation signal, or until the system 100 receives input from a human and/or machine, such as touch input provided by a human or an optical input provided by a bar code reader of a machine.

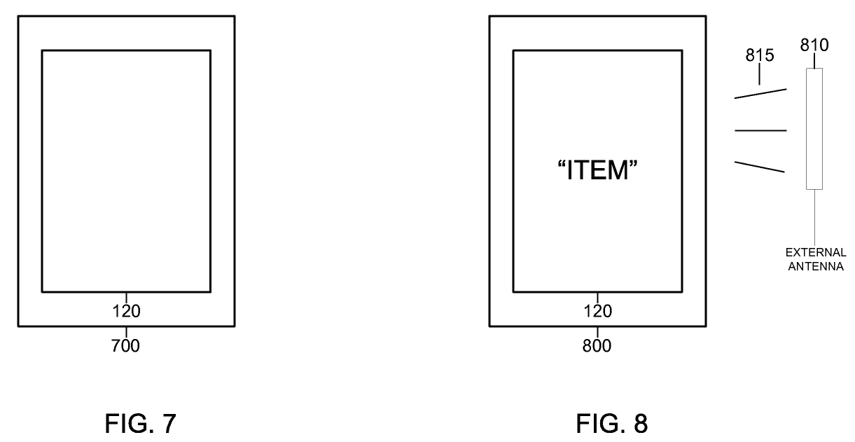

FIG. 7 illustrates an inactivated exemplary signal activated device 700 in the systems of FIG. 1, FIG. 2, and FIG. 3, or other systems for providing a configurable display for a signal activated device. Not all of the depicted components may be required, however, and some implementations may include additional components. Variations in the arrangement and type of the components may be made without departing from the spirit or scope of the claims as set forth herein. Additional, different or fewer components may be provided.

The signal activated device 700 may include a display 120. The display 120 may be powered off, or may otherwise not display data, while the signal activated device 120 is inactivated. In the case of a signal activated device 700 including a power source 310, the display 120 may display general data relating to the object the signal activated device 700 is attached to while the signal activated device 700 is inactivated. For example, the display 120 may display the name or address of the owner of the object the signal activated device 700 is attached to.

FIG. 8 illustrates an activated exemplary signal activated device 800 in the systems of FIG. 1, FIG. 2, and FIG. 3, or other systems for providing a configurable display for a signal activated device. Not all of the depicted components may be required, however, and some implementations may include additional components. Variations in the arrangement and type of the components may be made without departing from the spirit or scope of the claims as set forth herein. Additional, different or fewer components may be provided.

The signal activated device 800 may include a display 120. The signal activated device 800 may be activated by an external antenna 810. The external antenna 810 may be a radio frequency antenna, such as an antenna located in a warehouse. The external antenna 810 may generate activation signals 815, such as radio frequency signals. The signal activated device 800 may receive an activation signal 815, such as a radio frequency signal, from the external antenna 810. The signal activated device 800 may retrieve an item from memory and configure the display 120 to display the item. For example, in the FIG. 8, the displayed item may be the text “ITEM.” Alternatively or in addition, the retrieved item may be displayed in a machine-readable format, such as a bar code. The display 120 may continue to display the item until the signal activated device 800 moves out of range of the activation signals 815 generated by the external antenna 810.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method of providing a configurable display for a signal activated device, comprising:
receiving a radio frequency signal through an antenna, the radio frequency signal inducing a current in the antenna;
retrieving an item stored in a memory coupled with the antenna, in response to the radio frequency signal, using the current induced in the antenna; and
displaying the item using the current induced in the antenna.

2. The method of claim 1 wherein displaying the item using the current induced in the antenna further comprises displaying the item, on a display coupled with the memory, using the current induced in the antenna.

3. The method of claim 2 wherein the display comprises a low power electronically controllable display.

4. The method of claim 2 wherein the display comprises a plurality of organic light-emitting diodes.

5. The method of claim 2 wherein the display comprises a plurality of organic thin film transistors.

6. The method of claim 1 further comprising displaying the item in a machine readable format.

7. The method of claim 6 wherein the machine readable format comprises a bar code.

8. The method of claim 1 further comprising displaying the item in a human readable format.

9. The method of claim 1 further comprising:
determining whether a security criterion has been satisfied; and
displaying the item using the current induced in the antenna if the security criterion has been satisfied, otherwise not displaying the item.

10. A method of displaying data stored in a radio frequency identification device, comprising:
receiving an activation signal by a receiver of a radio frequency identification device;
retrieving an item from a memory of the radio frequency identification device in response to the activation signal; and
displaying the item on a display of the radio frequency identification device.

11. The method of claim 10 wherein the activation signal comprises a radio frequency signal.

12. The method of claim 10 wherein the activation signal comprises at least one of an optical signal, a magnetic signal, or an infra-red signal.

13. The method of claim 10 wherein the activation signal comprises a laser from a bar code reader.

14. The method of claim 10 wherein the activation signal is received from a touch sensor.

15. The method of claim 10 wherein the activation signal is received from a timer.

16. The method of claim 10 wherein the display comprises a low power electronically controllable display.

17. The method of claim 10 further comprising:
determining whether a security criterion has been satisfied; and
displaying the item on the display of the radio frequency identification device if the security criterion has been satisfied, otherwise not displaying the item on the display of the radio frequency identification device.

18. A method of verifying memory rewrites in a signal activated device, comprising:
receiving a radio frequency signal through an antenna, the radio frequency signal comprising an update item;
storing the update item in a memory coupled to the antenna using a current induced in the antenna by the radio frequency signal; and
displaying the update item using the current induced in the antenna.

19. A system for providing a configurable display for a signal activated device, comprising:
a receiver operative to receive a radio frequency signal;
a memory, coupled with the receiver, operative to store an item;
a processor, coupled with the memory, operative to retrieve the item stored in the memory, in response to the radio frequency signal, using a current induced in the receiver by the radio frequency signal; and
a display, coupled with the processor, operative to display the item using the current induced in the receiver.

20. The system of claim 19 wherein the receiver comprises a radio frequency antenna.

21. The system of claim 19 wherein the display comprises a low power electronically controllable display.

22. The system of claim 19 wherein the display comprises a plurality of organic light-emitting diodes.

23. The system of claim 19 wherein the display comprises a plurality of organic thin film transistors.

24. The system of claim 19 wherein the display is operative to display the item in a machine readable format.

26. The system of claim 19 wherein the display is further operative to display the item in a human readable format.

27. The system of claim 20 wherein the processor is further operative to determine whether a security criterion has been satisfied.
